(19) United States
(12) Patent Application Publication
(10) Pub. No.: US 2001/0037246 A1
(43) Pub. Date: Nov. 1, 2001

(54) Systems and methods for information management over a distributed network

(76) Inventors: Edmund C Reiter, Lincoln, MA (US); Michael A Tzannes, Lexington, MA (US)

Correspondence Address: NIXON PEABODY, LLP, 8180 GREENSBORO DRIVE, SUITE 800, MCLEAN, VA, 22102, US

(21) Appl. No.: 09/808,116

(22) Filed: Mar. 15, 2001

Related U.S. Application Data
(60) Provisional application No. 60/189,685, filed on Mar. 15, 2000.

(51) Int. Cl. G06F 17/60

(52) U.S. Cl. 705/20

(57) ABSTRACT

An information distribution system distributes information over a distributed network in a multi-phase manner. In particular, the information distribution system provides, for example, to an end user, a model for determining a particular output. Then, as a user requests the most current output of the model, a parameter set is forwarded to the user and introduced to the model. This parameter set, with the cooperation of the model, allows for determining, for example, a current merchants pricing information for a plurality of goods and/or services. By using this model based approach, the entire set of information need not be distributed to the user every time an update is made. To the contrary, only a sub-set of information, i.e., the parameters, will be forwarded to the user for updating of information at a user device.

### BACKGROUND OF THE INVENTION

1. Field of the Invention

This invention relates to managing information on a distributed network. In particular, this invention relates to efficiently distributing information over a distributed network.

2. Description of Related Art

Information management relates to efficient distribution and control of information. With a distributed network, such as the Internet, information is more readily available to everyone than ever before. Information management is extremely important for businesses that use the Internet. Distribution of information can be improved by making it easy to provide updated information in a timely manner. Control of access to information maintains contact with clients through the Internet.

The distribution of information over a distributed network, such as the Internet, typically involves a web server, i.e., a core server, which contains a database of the information that is desired to be distributed to multiple remote terminals, i.e., end users, that are running, for example, a web browser that allows the end user at their remote terminal to display the information in the database located at the web server. As an end user attempts to access information resident in the web server, a key element to the value of the information is often the speed at which it can be distributed. If a user requests a web site, for example by entering a URL or selecting a hyperlink, and the response time is too slow, the user may become frustrated. This is generally caused by the distribution of information between the server and the user being less than efficient.

In general, the response times can be improved by reducing the amount of information to be distributed through compression techniques. For example, JPEG, including the new JPEG2000 standard, is an example of a compression technology that is used to improve the efficiency of information distribution over the Internet. An image that is JPEG compressed can be represented with fewer bits than the original image and can be reconstructed at the remote site using the compressed data and a JPEG decoder. The JPEG decoder is the same for all JPEG images. By having a JPEG encoder at the server, and a JPEG decoder at the remote site, an image can be distributed more efficiently.

Another method for improving the efficiency is to increase the speed with which data is distributed using broadband technology. For example, by increasing the data rate of the transmissions between the core server and the end user, the same data can be transmitted in a shorter amount of time. Techniques for improving the speed of information distribution include cable modems and digital subscriber line (DSL) technologies.

Another way to improve response times seen by the end user is to decentralize the distributed network by placing remote servers at locations between the core server and the end user locations. These remote servers can duplicate portions of the information that is stored on the core, or the main server. By creating duplicate copies of information at remote locations in the network, the distance between the end user and the desired information is reduced, thereby reducing network congestion and consequently response times.

For example, a decision can be made at the remote server as to which information is to be duplicated and stored. There are numerous techniques to decide which information should be duplicated and stored. As an example, information that is frequently requested, such as a newspaper headline or, for example, certain stock quotes, can be duplicated and stored. Alternatively, all information from a certain popular site may be stored at the remote server.

Some exemplary issues that influence the effectiveness of a remote server include: access speeds between the remote server and the core server; the processing power of the remote server; the amount of memory available on the remote server; and the file system and/or disk space on the remote server.

Access speeds and memory can also be better utilized through compression and broadband technologies. Additionally, another way to enhance the effectiveness of the remote servers is to upgrade the hardware and the software platforms, or to increase the number of remote servers.

### SUMMARY OF THE INVENTION

An Internet user is often interested in accessing a server's database as that database changes with time. For example, the user may want to update stock prices accessed on the Internet and can do so by “refreshing” the stock quote information. The stock quote is then updated each time the user requests a “refresh.” Similarly, it is often desirable for the owner of the database to update the information being displayed at one or more user sites as certain information changes. For example, stock quote sites can automatically update the stock quote at user sites at predetermined intervals of time, such as, every few seconds to tens of seconds. Thus, access to and distribution of information that is constantly changing is one of the many characters of Internet usage.

A price of a product is a function of, among other things, the value of the product as perceived by a potential customer, and the number of products that a given company has in inventory. For example, a product that has cost of $1.00 may be offered by one business who has 1,000 products in inventory at a lower price than a business that has 10 products in inventory. The price can factor in the upside that the business hopes to achieve and the downside that the business must protect against. A pricing model takes into account the factors that effect a business to determine the price that the business is willing to sell, or buy, a product. Many businesses have computer models for pricing their products. These models take as inputs, for example, the parameters that are most important to the business, for example, the cost, the inventory status, such as the amount and time in inventory, and the product version, and produce a price for the product. By using the pricing model, a new price for the product can be determined by updating the parameters that are used as inputs to the model.

The model itself can also change as, for example, the business objectives change or as an industry changes. The application of this model can apply to business that buy, sell or trade products. In particular, the model can be applied to businesses that trade stock, including options, that buy, sell or trade goods, services, futures, commodities, or the like. In business to business (B to B) commerce, efficiently managing information about products whose prices change rapidly, such as consumer electronics, is of significant value. In general, the methods and systems of this invention can be applied to any application where pricing information can be determined from a pricing model whose parameters can be represented by less data than the corresponding output price book. It is particularly effective when the pricing models change rapidly with time in relation to the capacity of the underlying network. Furthermore, the methods and systems of this invention can be applied to any application where information can be determined based on one or more parameters being input to a model.

Aspects to the present invention relate to providing more efficient management of information over a distributed network.

Aspects to the present invention also relate to providing a more efficient management of pricing information over the Internet through the use of distributed pricing models and transmission of parameters to these models.

Aspects to the present invention additionally relate to improving the speed with which pricing information can be distributed on the Internet.

Aspects to the present invention additionally relate to distributing the computations required to update pricing by distributing pricing models to users.

Aspects to the present invention additionally relate to improving access to and distribution of information over a distributed network, such as the Internet, using a multi-tiered approach to distributing the information such that on a first time scale, the model that underlies the information to be distributed is distributed, and on a second time scale, or set of time scales, the parameters that are used as inputs to the model are distributed.

These and other features and advantages of this invention are described in, or are apparent from, the following detailed description of the embodiments.

### BRIEF DESCRIPTION OF THE DRAWINGS

The embodiments of the invention will be described in detail, with reference to the following figures, wherein:

FIG. 1 is a functional block diagram illustrating the relationship between the pricing model, the parameters, and the price book;

FIG. 2 is a function of block diagram illustrating an exemplary information distribution system according to one embodiment of this invention; and

FIG. 3 is a flowchart outlining an exemplary method for distributing information according to one embodiment of this invention.

### DETAILED DESCRIPTION OF THE INVENTION

Businesses that have products that they trade in, i.e., sell, and/or buy, are increasingly using the Internet to provide access to information relating to their products. Most notably, businesses are making available the prices at which there willing to buy and/or sell products. This information can consist of massive amounts of data, for example, prices for thousands of products, and the information is subject to change based on, for example, changes in the industry.

An example of this is the information that surrounds the options to buy or sell stock. The price of these options is affected by, for example, the current and the historical price of the stock. There is also a price at which traders are willing to buy or sell the option for a given date. This is related to the current and historical price of the stock as well as the positions that the trader holds in the option. The price of the stock can change rapidly, for example, at intervals of less than one second. Thus, each time there is a change of price, the option price at which a trader is willing to sell or buy the stock may change.

As previously discussed, compression in broadband technologies can be used to improve access to information on the Internet. Additionally, the use of remote servers to decentralize the information will generally improve response times. However, prior art technologies do not take advantage of the ability to represent information using a model, and a set of parameters to describe and be used as inputs to the model.

According to one embodiment, the systems and methods of this invention utilize a pricing model to determine a price book by distributing a set of parameters. For example, and in accordance with one embodiment of the present invention, the businesses that trade in a product distribute a pricing model, for example, in the form of a software program or software component which can run on a users computer, through a distributed network, such as the Internet, to the users computer at regular intervals, for example, once per month. In order to distribute the pricing information, the businesses can periodically transmit one or more parameters to the user. These parameters are introduced to the pricing model, that may, for example, reside on the users computer, to produce a local copy of the price book. These parameters can be updated more frequently than the pricing model itself, for example, from multiple times a day to once every few seconds or even faster. In general, the parameters can be distributed at any interval as deemed necessary by one or more of the business and user.

By distributing the pricing model and updating the price book by updating the parameters that are fed to the pricing model, the business is able to efficiently manage information about its book price. Thus, business can efficiently distribute their pricing information because the amount of information that needs to be updated, in the form of the parameters that are input to the pricing model, is far less than the complete price book itself. The complete price book is thereby made available to the user in a way that does not require the entire book price to be transmitted over the Internet, relating to inefficiency. The result is that the end user obtains access to the entire price book with reduced response times. This is a benefit to the business since, for example, the end user is less likely to go elsewhere to obtain pricing information because of slow response times.

The parameters can change at different times. For example, certain parameters may be updated in intervals measured in minutes. Other parameters may be updated in intervals measured in seconds. Thus, the pricing models can maintain the value of parameters as inputs until the parameters are updated. This allows the parameter inputs to change at different times as, for example, they are updated, or become available. Additionally, the pricing models can maintain an identification of the importance level of a parameter and, for example, automatically update the parameter based on a predefined update rate associated with that parameter.

For example, assume a product whose price depends upon the following parameters:

a=the number of days until the end of the fiscal quarter,

b=the current inventory,

c=the customer volume in quarter,

d=the starting inventory

e1=a discount factor 1

e2=a discount factor 2

e3=a discount factor 3

e4=a gross margin factor, and

f=the cost, including suppliers costs.

Then, an exemplary pricing model can be represented as:

Price=function (a, b, c, d, e1, e2, e3, listprice)=listprice*(1−e1*c/d−e2* b/d −e3* (1−a/(days in quarter)+e4* f/pricelist))

The pricing model is a function that can be delivered infrequently. Parameter a changes daily. Parameters b and c change more frequently. Factors e1, e2, e3, e4 can change at any time based upon business objectives (e.g. margin, top line revenue, customer satisfaction). Factor f can change frequently as well.

As another example, in the case of a price book for options, the inventory of a given trader may change every hour, whereas the price of the security related to the option, may change in sub-second intervals. The price book can be updated as, for example, the price of the security changes. The initial parameters for the pricing model can, for example, be distributed each morning, and can be updated as the inventory, i.e., the traders position in the options, can be updated as the inventory changes, such as, hourly or sub-hourly, and the security on a tick-by-tick basis, such as, sub-second intervals. Thus, users will see the trader's price book updated on a tick-by-tick basis as well as each time the trader's position changes. While the entire book will be provided to the user, only a small set of parameters are actually transmitted over the Internet from time to time. This results in the trader being able to practice efficient information management. Without the present invention, the entire price book would need to be transmitted to the user on a tick-by-tick basis. This would require large amounts of information to be transmitted over potentially large distances on the Internet in a very short amount of time.

Another aspect of information management is the ability to control the distribution of information over the Internet. With the present invention, it is possible for a central web server, i.e., the core server, to use, for example, the most frequently updated parameter, for example, a parameter that is being updated once per second, to also signal the remote site, e.g., the user, that another set of updated parameters, which may change less frequently, are available. This updated set of parameters is input to the model at the remote site to update the price book. The use of multi-tiered distribution of information from the web server to the remote site allows the information at the remote site to be kept current.

In the above example, involving stock options, the price of the stock is updated quite frequently, for example, in sub-second intervals. This updating is a low-bandwidth event, i.e., an updated price is used to update the price book by inputting parameters regarding the updated price into the model that is resident on the remote site. A second set of parameters that changes less frequently, such as every sub-hour are the trader's position in the options. When these parameters change and need to be updated to provide an updated price list, the server can send a message attached to a price update that signals the user's computer that updated parameters are available. The remote computer then knows to request a new set of the less frequently changed parameters. With this technique, the amount of the information that needs to be transmitted over the Internet is limited to that information that has changed, since the updated parameters set is distributed only when the updated parameter set changes.

An additional aspect of this invention is the ability to maintain access to an end user. Since the price book is updated by the user establishing access to a web server and obtaining new parameters as they are updated, the end user is kept in contact with the business's web server. This means that the business maintains access to the user, and control of the information that it provides to the user.

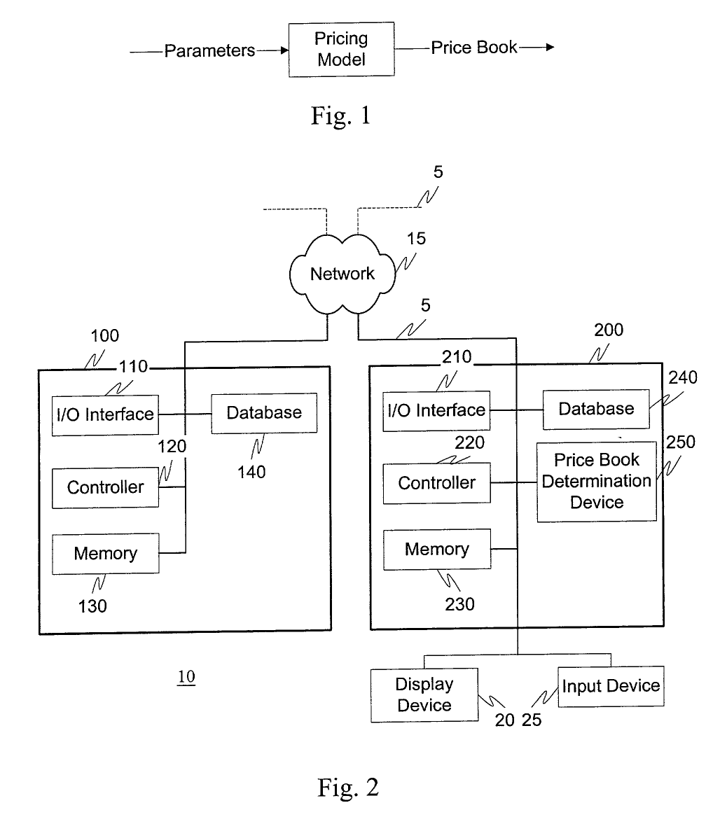

FIG. 1 illustrates the relationship between the pricing model, the parameters and the price book. In particular, the parameters are input into the pricing model. The pricing model, which can be, for example, an algorithm, that uses these parameters, is then capable of determining the price book. The “price book” is used herein refers to an assembly of price information that can relate to any goods and/or services. In general, the pricing model can be any system or technique that receives one or more inputs and determines one or more prices based at least on the inputs.

FIG. 2 illustrates an exemplary information distribution system 10 according to an embodiment of this invention. The information distribution system 10 comprises a server 100 and user device 200. The server 100 comprises an I/O interface 110, a controller 120, a memory 130 and a database 140, interconnected by link 5. Additionally, the server 100 is connected, via link 5, to one or more networks 15, such as a distributed network, and a user device 200. The user device 200 comprises an I/O interface 210, a controller 220, a memory 230, a database 240 and a price book determination device 250, interconnected by link 5. The user device 200 is also connected, via link 5, to one or more networks 15 and a display device 20 and an input device 25. The information distribution system 10, while illustratively shown connected to one network 15, and having only one user device, may also be connected to one or more additional information distribution systems, user devices or other networks, as well as one or more input devices and display devices.

While the exemplary embodiment illustrated FIG. 2 shows the information distribution system 10 and associated components collocated, it is to be appreciated that the various components of the information distribution system 10 can be located at distant portions of a distributed network, such as a local area network, a wide area network, and intranet/or the Internet, or a dedicated information distribution system. Therefore, it should be appreciated, that the components of the information distribution system 10 can be combined into one device or located on a particular note of a distributed network. As will be appreciated from the following description, and for reasons for computational efficiency, the components of the information distribution system can be arranged at any location within a distributed network without affecting the operation of the system.

Furthermore, the links 5 can be a wired or wireless link or any other known or later developed element(s) that is capable of carrying electronic data to and from the connected elements. Additionally, the input device 25 can be a keyboard, a mouse, a speech to text converter, a touch screen, or any other device capable of inputting information the user device 200. The display device 20 can be a computer monitor, a display on a PDA, a printer, a graphical user interface residing on a computer, or any other device capable of displaying information to one or more users.

In operation, the parameters and pricing models are input to the server 100 and stored in the database 140 with the cooperation of I/O interface 110, the controller 120, and memory 130. Thus, the server 100 can be a web server or other computer configured to allow one or more users to access information stored in the database 140. The user, using user device 200, requests pricing information from, for example, a merchant controlling the information on server 100. The user device 200, in cooperation with the I/O interface 210, the controller 220 and the memory 230 requests, via the link 5 and the network 15, the pricing model from the database 140. This pricing model is stored in database 240. Then, upon a user indicating a desire for obtaining current pricing information, for example, via the input device 25, the user device 200 requests the current parameter set from the server 100. The current parameter set is returned, via network 15 and the link 5 to the user device 200 and stored, with the cooperation of the I/O interface 210, the controller 220 and the memory 230, in the database 240. Next, the price book determination device 250, with the cooperation of the controller 220 and memory 230, determines a current price book based on the current parameter set and the pricing model. The current price book can then be output, for example, on the display device 220.

Then, for example, at any predetermined interval, or upon a user request, the parameters for determining the price book can be updated as needed. For example, the price book could have a multi-tiered structure that allows for updating of certain parameters on a first time schedule, such as, every second, and a second set of parameters that are updated, for example, on a weekly basis. Similarly, the pricing model can have embedded therein automatic updating instructions that instruct the user device 200 to request a new pricing model from the server, for example, at a predetermined time interval, such as, once a month. Thus, not only is the user able to obtain the latest pricing information, but, for example, a merchant, supplying information to the server 100, is also able to maintain a relationship with the user as previously discussed.

Alternatively, instead of the pricing model and associated parameters being stored on the database 140, the pricing model and associated parameters can be determined “on the fly” or can be requested from a number of different sources. For example, using ActiveX, or Java®, the pricing model can be determined dynamically based upon, for example, a user request, and forwarded directly to an end user. Similarly, the parameters may not necessarily be stored on the server 100, but may be present on one or more servers and assembled for input to the model. For example, one parameter may come from a wholesaler, one parameter from the merchant, and another parameter from a shipping agent. Thus, the parameters could, for example, be assembled from a static location or also determined in real-time or near-real time.

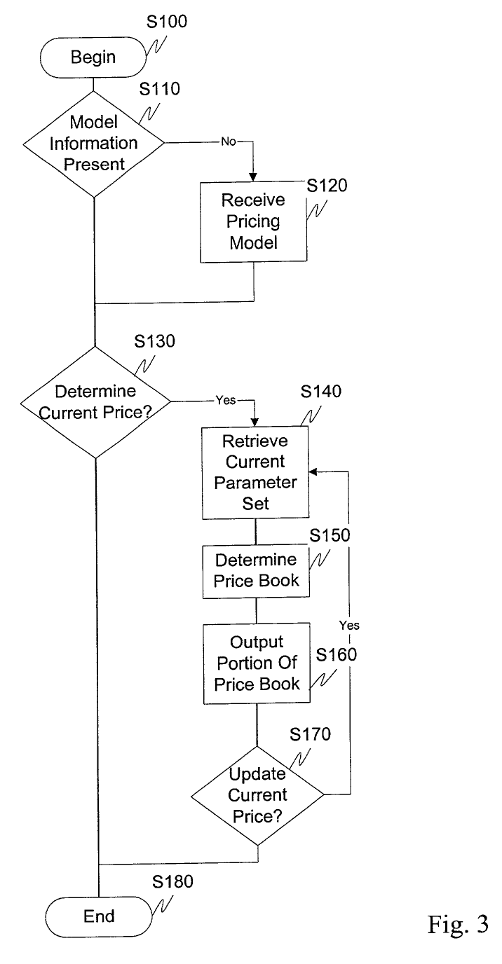

FIG. 3 illustrates a flowchart outlining the exemplary embodiment for distributing information. In particular, control begins step S100 and continues to step S110. In step S110 a determination is made whether the current pricing model information is present on the user device. If the current pricing model information is present, control jumps to step S130. Otherwise, control continues to step S120. In step S120, the current pricing model information is received. Control then continues to step S130. In step s130, a determination is made whether the current price information is desired. If the current price is desired, control continues step S140. Otherwise, control jumps to step S180 where the control sequence ends.

In step S140, the current parameter set is retrieved. Next, in step S150, the price information, such as a price book, is determined. Then, in step S160, all or a portion of the price book is output. Control then continues to step S170.

In step S170, a determination is made whether one or more portions of the current price should be updated. If updates are needed, control jumps back to step S140. Otherwise, control continues to step S180 where the control sequence ends.

As shown in FIG. 2, the information distribution system can be implemented either on a single program general purpose computer, or a separate program general purpose computer. However, the information distribution system can also be implemented on a special purpose computer, a programmed microprocessor or micro-controller and peripheral integrated circuit element, an ASIC or other integrated circuit, a digital signal processor, a hard-wired electronic or logic circuit such as a discrete element circuit, a programmable logic device such as a PLD, PLA, FPGA, PAL, or the like. In general, any device capable of implementing a finite state machine that is in turn capable of implementing the flowchart illustrated in FIG. 3 can be used to implement the information distribution system according to this invention.

Furthermore, the disclosed method may be readily implemented in software using object or object-oriented software development environments that provide a portable source code that can be used on a variety of computer or workstation hardware platforms. Alternatively, the disclosed information distribution system can be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or micro-computer systems being utilized. The information distribution systems and methods illustrated herein however, can be readily implemented in hardware and/or software using any known or later developed systems or structures, devices and/or software by those of ordinary skill in the applicable art without departing from the functional description provided herein and with a general basic knowledge of the computer arts.

Moreover, the disclosed methods may be readily implemented as software executed on a programmed general purpose computer, a special purpose computer, a microprocessor, or the like. In these instances, the methods and systems of this invention can be implemented as a program embedded on a personal computer or as an add on or plug-in to a web browser, such as a Java™ or CGI script, as a resource residing on a server or graphics workstation, as a routine embedded in a dedicated information distribution system, a web browser, an electronic message enabled cellular telephone, a PDA, a dedicated price book management system, or the like. The information distribution system can also be implemented by physically incorporating the system into a software and/or hardware system, such as the hardware and software systems of a personal computer or dedicated information distribution system.

It is, therefore, apparent there has been provided, in accordance with the present invention, systems and methods for distributing information. While this invention has been described in conjunction with a number of embodiments, it is evident that many alternatives, modifications and variations would be or are apparent to those of ordinary skill in applicable arts. Accordingly, applicants intend to embrace all such alternatives, modifications and variations that are within the spirit and scope of this invention.

What is claimed is:

1. An information distribution system comprising:
a pricing model; and
one or more parameters, wherein the parameters are distributed to the pricing model which determines a price list based at least on the one or more parameters.

2. The system of claim 1, wherein the distribution of the parameters consumes less bandwidth than distribution of the price list.

3. The system of claim 1, wherein the pricing model is associated with an internet browser.

4. The system of claim 1, wherein the one or more parameters can be updated at various times.

5. A method of updating information over a distributed network comprising:
distributing a price model; and
distributing one or more parameters to the price model, wherein the price model determines a price list.

6. The method of claim 5, wherein the one or more parameters can be updated at a plurality of different times.

7. The method of claim 5, wherein the one or more parameters are updated based on a request from one or more of the price model, a user device and a server.

8. A method of updating information at a user site over a distributed network comprising:
transmitting a model to the user site, the model used to determine information; and
transmitting a set of parameters to the user site, the parameters used to at least one of update the model and determine the information.

9. The method of claim 8, wherein the information is at least one of price information and merchant information.

10. A method of maintaining communication with a user comprising:
distributing one or more parameters to a user at a user device, the one or more parameters used to update a model, wherein the parameters themselves request updating of the one or more parameters.

11. The method of claim 10, wherein the one or more parameters that are used more frequently are used to indicate that the parameters that are used less frequently need updating.

12. An information storage media comprising information that updates information at a user site over a distributed network comprising:
information that transmits a model to the user site, the model used to determine information; and
information that transmits a set of parameters to the user site, the parameters used to at least one of update the model and determine the information.

13. The information storage media of claim 12, wherein the information is at least one of price information and merchant information.
